(19) United States
(12) Patent Application Publication
(10) Pub. No.: US 2018/0220331 A1
(43) Pub. Date: Aug. 2, 2018

(54) MANAGING TRAFFIC LOAD IN A DISTRIBUTED ANTENNA SYSTEM

(71) Applicant: KABUSHIKI KAISHA TOSHIBA, TOKYO (JP)

(72) Inventors: Stephen WANG, Bristol (GB); Fengrning CAO, Bristol (GB)

(73) Assignee: KABUSHIKI KAISHA TOSHIBA, TOKYO (JP)

(21) Appl. No.: 15/506,273

(22) PCT Filed: Mar. 20, 2015
(86) PCT No.: PCT/GB2015/050829

§ 371 Date: Feb. 24, 2017

(51) Int. Cl. H04W 28/08; H04W 28/02; H04B 7/06; H04B 7/022; H04W 64/00

(52) U.S. Cl. CPC H04W 28/085; H04W 28/0226; H04W 64/003; H04B 7/022; H04B 7/0691

(57) ABSTRACT

A controller for a distributed antenna system (DAS). The DAS has a plurality of antenna units. Each antenna unit is operable at a first frequency band, defining a first network. The controller comprises a processor; the processor is configured to receive a geo-location traffic specification. The geo-location traffic specification has an indication of a location of a device using the DAS and a traffic requirement of the device. The processor is further being configured to: select an antenna unit or group of antenna units to operate on the first network, based on the received geo-location traffic specification; wherein the antenna unit or group of antenna units is selected to meet the traffic requirement of the device with respect to the first network, in the location of the device.

### FIELD

Embodiments described herein relate generally to managing distributed antenna systems.

### BACKGROUND

The increasing use of smart phones and computing devices is leading to network requirements becoming more and more heterogeneous, that is, different types of cells operating on different networks coexisting in the same area and overlapping each other. A common example of hybrid heterogeneity is the overlapping of cellular networks (such as an LTE network) and wireless local area networks (i.e. Wifi). In response to the increased traffic load on certain networks, cellular communication with Wifi offloading—where mobile cellular traffic (such as LTE) is partially offloaded to Wifi—is becoming increasingly prevalent as a tool to manage traffic load.

A distributed antenna system (DAS) is a series of spaced apart antennas located within a geographic area or structure which are often connected to a common source. Distributed antenna systems provide network coverage for a certain geographical area and are frequently installed in offices or shopping centres. The typical DAS operates on a single frequency band, herein referred to as a “network”, for example the LTE network. Such an arrangement is dedicated to providing coverage for a single network provided by a single network operator.

As consumer traffic load continues to increase. It is likely that Wifi offloading and other related technologies will be more frequently used. This means that network systems will become increasingly heterogeneous and that distributed antenna systems will need to support more than a single network. Although current distributed antenna systems may provide coverage for two networks (e.g. Wifi and cellular network) using separate, dedicated antennas, this can be inefficient and it has been found desirable to provide a system whereby the antenna usage and traffic load handling is more effectively optimised than such an arrangement permits.

### BRIEF DESCRIPTION OF THE DRAWINGS

FIG. 1A schematically illustrates a single network DAS according to a prior art embodiment;

FIG. 1B schematically illustrates a multi-network DAS according to a prior art embodiment;

FIG. 2A schematically illustrates a DAS according to a prior art embodiment providing a LTE cellular network;

FIG. 2B schematically illustrates a DAS according to a prior art embodiment providing two LTE cellular networks;

FIG. 2C schematically illustrates a DAS according to a prior art embodiment providing a Wifi network;

FIG. 2D schematically illustrates a DAS according to a prior art embodiment providing two Wifi networks;

FIG. 3 schematically illustrates a DAS according to an embodiment providing Wifi and a LTE network at three different time slots;

FIG. 4 schematically illustrates a DAS according to an embodiment providing multiple networks at a first and second time slot;

FIG. 5 schematically illustrates a DAS according to an embodiment providing multiple networks in five different configurations;

FIG. 6 is a flow diagram illustrating a time slot for use in an embodiment;

FIG. 7 schematically illustrates a controller according to an embodiment;

FIG. 8 is a flow diagram illustrating a method according to an embodiment;

FIG. 9 schematically illustrates an implementation of a time slot according to an embodiment;

FIG. 10 schematically illustrates an implementation in accordance with a method of an embodiment; and

FIG. 11 illustrates an example of a traffic request message in accordance with a method of an embodiment.

### DETAILED DESCRIPTION

According to an embodiment is a controller for a distributed antenna system (DAS), the DAS comprising a plurality of antenna units, wherein each antenna unit is operable at a first frequency band, defining a first network;
wherein the controller comprises a processor;
   the processor being configured to:
      receive a geo-location traffic specification; wherein the geo-location traffic specification comprises an indication of a location of a device using the DAS and a traffic requirement of the device;
   the processor being further configured to:
      select an antenna unit or group of antenna units to operate on the first network, based on the received geo-location traffic specification;
      wherein the antenna unit or group of antenna units is selected to meet the traffic requirement of the device with respect to the first network, in the location of the device.

An antenna unit may be further operable at a second frequency band, defining a second network.

Each antenna unit may be further operable at a second frequency band, defining a second network.

In some embodiments the DAS may comprise a plurality of antenna units, wherein at least one antenna unit is operable at a first frequency band, defining a first network; and at least one antenna unit is operable at a second frequency band, defining a second network. The antenna unit or plurality of antenna units operable on the first network may not be the same as the antenna unit or plurality of antenna units operable on the second network.

The geo-location traffic specification may comprise an indication of a location of multiple devices and a traffic requirement of multiple devices.

The processor may alternatively be configured to: receive geo-location traffic data of a device using the DAS; and select an antenna unit or group of antenna units to operate on the first network, based on the acquired traffic data.

The antenna unit or group of antenna units may be selected to provide coverage of the first network for the device.

Alternatively, the antenna unit or group of antenna units may be selected to optimise network coverage for the device.

A single network (e.g. a Wifi network or a 4G LTE cellular network) generally operates within a fixed frequency band. As such, the terms “frequency band” and “network” are to be considered to be largely interchangeable in the present disclosure, unless such an understanding is obviously inappropriate from the context.

A distributed antenna system may comprise a plurality of antenna units distributed over a specific location in order to provide coverage for one, or multiple, networks. Such coverage allows devices to transmit and receive over the specific network, for example a wireless station (STA) such as a laptop may connect to a local wireless network (“Wifi”) or user equipment (UE) such as a mobile phone may connect to a cellular network, such as “4G LTE”.

In an embodiment, coverage refers to the ability of devices using the DAS to transmit data over a network, or to receive data over a network, or to transmit and receive data over a network. Coverage may refer to the ability to effectively connect and transmit/receive over the first network, a second network and/or a subsequent network. It is to be understood that the term “transmit”, as used in the present disclosure, may also cover “receive” unless it is clearly inappropriate from the context. The ability to transmit over a network is considered to be analogous to the ability to receive over a network when referring to the network coverage required.

Any number of devices may use the DAS. This number may fluctuate with time. Devices using the DAS may comprise devices that are already transmitting using the DAS, as well as devices that are within the coverage area of the DAS and are initiating, or attempting to use the DAS.

Distributed antenna systems according to an embodiment may be installed in indoor or outdoor locations. Such locations may be populated areas such as shopping centres, offices, parks or other inner city areas.

According to an embodiment, a controller is configured to dynamically manage traffic of a, or multiple, devices using a DAS. A controller may be configured to manage the antenna operation in a DAS.

A controller according to an embodiment may be part of, or installed in a device such as a base station which may monitor and control a distributed antenna system. A single base station may monitor and control the DAS, or a series of networked base stations may monitor and control the DAS. Each base station in a series of networked base stations may be associated with a plurality of antenna units which constitute a subset of all the antenna units of the DAS.

According to an embodiment, an antenna unit, or each antenna unit may be operable on a single network.

According to a further embodiment, an antenna unit, or each antenna unit may be operable on two networks, a first and a second network. An antenna unit may only be able to operate on a single network at a time. As such, a (or each) antenna unit may be able to provide coverage for one of two different wireless networks at a time and switch between these networks. In an embodiment, each antenna unit is only operable on a single network at a specific time; in other embodiments, however, an antenna unit may be able to operate on multiple networks simultaneously.

In some embodiments, an antenna unit may operate on more than one network simultaneously by providing more than one antenna. The antennas in an operating unit may be spaced to manage in-device interference.

In some embodiments, each antenna unit may be operable on more than 2 networks, e.g. three, four or five networks.

The processor is configured to acquire, or receive, a geo-location traffic specification. A geo-location traffic specification may comprise geo-location traffic specification information for the first network (i.e. a single network). A geo-location traffic specification may additionally comprise geo-location traffic specification information for a second network and/or a subsequent network. The geo-location traffic specification may comprise traffic specifications for a plurality of networks.

A geo-location traffic specification may comprise information regarding devices using the DAS. The information may provide a measure of the traffic demands, or the “traffic requirement” of the device, on the DAS, such as the network, bandwidth and QoS priority required. The information may also provide an indication of the geographical location of the traffic demands. The geo-location traffic specification may comprise an indication of a location of a device using the DAS and a traffic requirement of the device. A geo-location traffic specification may comprise an indication of the locations of a plurality of devices using the DAS and traffic requirements for each of these devices. The location may be determined as being the transmission range of a specific antenna unit. This information may be embodied in, or derived from geo-location traffic data.

A geo-location traffic specification may comprise an indication of the location of a, or a plurality of, devices using the DAS, this indication may originate from an antenna unit. The geo-location traffic specification may comprise a traffic requirement of a, or a plurality of, devices, this may originate from the, or the plurality of, devices using the DAS.

A geo-location traffic specification may comprise or be derived from geo-location traffic data of devices using the DAS. A geo-location traffic specification may be a summation of geo-location traffic data. A geo-location traffic specification may be a collection of geo-location traffic data.

The processor may be configured to receive a geo-location traffic specification from each antenna unit and/or database. Alternatively, the processor may be configured to receive a single geo-location traffic specification incorporating geo-location traffic data from a plurality of antenna units and/or databases.

Geo-location traffic data may also be termed location-aware traffic and may be embodied by device traffic, or information regarding device traffic, which has a geographical area of origin associated with it or can be traced to a certain geographical area. Geo-location traffic data may be information regarding the location and traffic requirements of devices. Geo-location traffic data may comprise QoS-based traffic prioritisation information. Geo-location traffic data may be used to estimate the network traffic demands of devices using the DAS for specific regions or locations within the DAS. Geo-location traffic data may comprise signalling parameters from devices using the DAS.

Different networks may specify different protocols for geo-location traffic data, but in general, traffic data may comprise any or all of the following information: an indication of the network and bandwidth required, an indication of the geographical location of the device (this may be indicated by an indication of the antenna unit used) and an indication of any QoS specifications. This geo-location traffic data may then be used to provide a geo-location traffic specification.

The protocols, commands and algorithms used by devices operating on a network are generally dictated by standards which are publically available. An example of such a standard is IEEE Std 802.11-2012, and in particular part 11, which relates to wireless LAN medium access control and physical layer specifications.

A number of methods exist to acquire location and traffic information. For example, an indication of a location of a wireless device using the DAS may be obtained through Cell-ID methods, wherein the identification of the serving cell provides an estimate on the device's location; assisted GPS, wherein device GPS units are used to obtain a location; and triangulation between known points.

One example related to Cell-ID methods as discussed above is used in an embodiment. In a DAS each device may be associated with a different antenna unit or units. As devices move around within the DAS, they change associations using protocols dictated by standards for the respective networks. Such protocols may require interaction between the device and an antenna unit, this information provides an estimate of the location of the device by being associated with the receiving antenna and information regarding its traffic, including any QoS specifications. An antenna unit may store this geo-location traffic data relating to associated devices. This data may be used to produce a geo-location traffic specification which may be sent to the controller/processor in accordance with an embodiment described herein.

The geo-location traffic specification may be an accumulation of geo-location traffic data received from a plurality of devices, by an antenna. The geo-location traffic specification may specify the total requirements for a plurality of networks in the locality of the antenna. The geo-location traffic specification may be in the form of collected geo-location data, or data extracted from collected geo-location traffic data.

The processor may be configured to receive a geo-location traffic specification (or geo-location traffic data) from an antenna and/or a database.

A processor may be configured to select a first (or subsequent) antenna unit or first (or subsequent) group of antenna units to operate on the first (or subsequent) network, based on the received geo-location traffic specification; wherein the antenna unit or group of antenna units is selected to meet the traffic requirement of devices represented in the geo-location traffic specification with respect to the first (or subsequent) network respectively, in the location of the respective device.

As such, a plurality of antenna units or groups of antenna units may be selected to operate on a single or plurality of networks respectively, to meet the traffic requirements of a single or plurality of devices in their respective locations. This objective is achieved through the use of the geo-location traffic specification. A processor according to an embodiment may be configured to select an antenna unit or group of antenna units (or subsequent antenna unit or group of antenna units) to operate on a first (or subsequent) network, based on the received traffic specification; wherein the antenna unit or group of antenna units is selected to provide coverage of the first (or a subsequent) network for a, or for all, device(s) using the DAS. The coverage allows the device to transmit and/or receive over the first network, using the DAS.

A processor according to an embodiment may be configured to select an antenna unit or group of antenna units (or subsequent antenna unit or group of antenna units) to operate on a first (or subsequent) network, based on the received traffic specification; wherein the antenna unit or group of antenna units is selected to fulfil first (or subsequent) network requirements of the geo-location traffic specification.

Fulfilling, or meeting the respective network requirement may be providing sufficient coverage of the respective network to meet the traffic requirement with respect to those networks. Thus, allowing the device(s) to transmit and/or receive over the network, using the DAS. Fulfilling, or meeting the respective network requirement may alternatively be providing sufficient coverage such that a certain percentage of device traffic can be transmitted and/or received using the DAS.

The antenna selection (the configuration of antenna units acting on a first and/or second network) may be determined based on the geo-location traffic specification. The geo-location traffic specification may be used to determine an estimate of where devices are located and what network they are, or are requesting, using. The antenna selection may be made such that all devices using the network (or all devices using the network for which geo-location traffic data has been received) are able to transmit and/or receive data over their chosen network in their location.

A processor may be configured to select an antenna unit or group of antenna units (or subsequent antenna unit or group of antenna units) to operate on a first (or subsequent) network; wherein the antenna unit or group of antenna units is selected to optimise coverage for devices using the DAS.

A processor may be configured to select an antenna unit or a group of antenna units to operate on the first network. The selected antenna unit or group of antenna units may be chosen such that coverage of the first network (to enable devices using the DAS to transmit and/or receive using the first network) is optimised. The selected antenna unit or group of antenna units may be chosen such that coverage of a second network is optimised. Optimised coverage may allow devices using the DAS to more readily, more quickly or more easily transmit and/or receive data over the first network (and any subsequent network) when compared to coverage that is not optimised. Optimised coverage may also eliminate redundancies and minimise surplus power consumption, by deactivating antenna units that are surplus to current demand. Measures of what constitutes optimised coverage may be determined by network standards, the network operator, the DAS operator or manufacturers.

A processor may alternatively be configured to select an antenna unit or group of antenna units (or subsequent antenna unit or group of antenna units) to operate on a first (and/or subsequent) network; wherein the antenna unit or group of antenna units is selected to improve, or change, the coverage for devices using the DAS.

The antenna unit or group of antenna units may alternatively be selected to operate on the respective network to improve network coverage for devices using the DAS at a time t₂, compared to a previous time t₁.

The processor may be configured to use a geo-location traffic specification or geo-location traffic data to derive a traffic estimate, wherein a traffic estimate is an estimate of the location and traffic type (or network requirement, including QoS specifications) of a device.

The processor may be configured to select an antenna unit or group of antenna units to operate on the first network, based on the traffic estimate, such that the estimated traffic type can be transmitted and/or received or the network requirements of the device can be met. A second (or subsequent) antenna unit or group of antenna units may be selected to operate on the second (or subsequent) network, based on the traffic estimate, such that the estimated traffic type can be transmitted and/or received or the network requirement of the device(s) can be met. A further antenna unit or group of antenna units may be selected to enter an idle mode, based on the traffic estimate, due to there being no traffic requirements in their location.

The antenna selection may be made based on a short-term geo-location traffic specification, which allows estimates of current device locations, network and QoS requirements to be obtained.

The antenna selection may alternatively be made using a historic geo-location traffic specification (see below), which may also allow an estimate of device locations, network and QoS requirements. The estimations may be based on, or derived from, historical geo-location traffic specifications by assuming that certain patterns or correlations exist between historic geo-location traffic specifications and current geo-location traffic specifications.

The result of the antenna selection may be that whereas in a traditional DAS every antenna unit is operating on a single network all the time, in an embodiment only certain antenna units are operating at a time. In some embodiments, these antenna units may provide one of a plurality of networks. In an alternative embodiment, all the antenna units may be operating all the time, but may be operating on different networks and may change networks over time, based on the geo-location traffic specification. The arrangement of active antenna units and the networks on which they are operating may change over time in response to changes in the geo-location traffic specification.

An, or each, antenna unit may be further operable at a second frequency band, defining a second network.

The geo-location traffic specification may further comprise an indication of a location of a second device using the DAS and a traffic requirement of the second device; and
the processor may further be configured to select a second antenna unit or second group of antenna units which are operable on the second network to operate on the second network, based on the received geo-location traffic specification; wherein
the second antenna unit or second group of antenna units is selected to meet the traffic requirement of the second device using the DAS with respect to the second network, in the location of the second device.

An, or each, antenna unit may be further operable at a further frequency band, defining a further network.

The geo-location traffic specification may further comprise an indication of a location of a further device using the DAS and a traffic requirement of the further device; and
the processor may further be configured to select a further antenna unit or further group of antenna units to operate on the further network, based on the received geo-location traffic specification; wherein
the further antenna unit or further group of antenna units may be selected to meet the traffic requirement of the further device using the DAS with respect to the further network, in the location of the further device. Thus, any number of groups of antennas may be selected to meet traffic requirements for any number of devices operating on any number of networks.

Furthermore, the second or further device may be the same device as the first (or second) device. As such, a single device may have traffic requirements for a plurality of networks.

The processor may alternatively be configured to select a second antenna unit or second group of antenna units to operate on the second network, based on the acquired traffic specification. The second antenna unit or second group of antenna units may be selected to meet second network requirements of the geo-location traffic specification.

In some embodiments, the controller, by means of the processor, may allocate an antenna unit or group of antenna units to operate on a first wireless network and a second antenna unit or group of antenna units to operate on a second wireless network. In this manner coverage for a plurality of different wireless networks can be provided by the same DAS, simultaneously. Providing a plurality of different networks over the same DAS allows different devices within the DAS to operate on different networks, e.g. a mobile phone to access a cellular network (such as an LTE network) to make a call; and a laptop to use Wifi to access the internet. It also allows “Wifi offloading” or other load handover techniques, e.g. whereby cellular traffic is offloaded to Wifi. This can increase network capacity.

The second antenna unit or second group of antenna units may meet the second network requirements of the geo-location traffic specification by providing sufficient coverage of the second network for devices using the DAS.

In an embodiment, each antenna unit may be operable on a first, second and third network and the processor may be configured to select a third antenna unit or third group of antenna units to operate on a third network. There may be more than three networks, e.g. four, five etc and the processor may be configured to select an antenna unit or group of antenna units to operate on each respective network, based on the received traffic specification in the same manner as discussed above. There may be between 2 and 20 networks.

In an embodiment, the second antenna unit or second group of antenna units and the first antenna unit or group of antenna units are mutually exclusive, i.e. an antenna unit either operates on the first network, or the second network. In other embodiments, however, they may not be mutually exclusive, and antenna units may operate on both a first and a second network simultaneously, as discussed above.

As part of implementing the antenna configuration (or “antenna selection”) selected by the processor in embodiments where an antenna is operable on more than a single network, an, or each, antenna unit may be required to switch between the first, second or further network. This means that an antenna unit operating on a first network may be required to change to operate on a second network.

Alternatively, an antenna unit which was previous switched off, or in an idle mode, may be required to operate on a network.

Instead of having to operate on a network, an antenna unit may be required to switch off, or to enter an idle mode. This may be to save power when coverage is not required at the location of the respective antenna unit.

Intelligent switches and MUX units may be employed in a controller according to an embodiment. These may allow the antenna units to work either collaboratively or independently in a DAS.

An antenna unit may be required to implement operation bandwidth flexibility, for example by using methods such as carrier aggregation to reconfigure the operational bandwidth in the DAS.

An antenna unit may be required to reconfigure beacon frame parameters to effectively manage the load and traffic. For example, if geo-location traffic data cannot be obtained by traditional methods such as NAS Attach Requests or ADDTS signalling parameters (see below), new parameters may be required to allow a geo-location traffic specification to be obtained or derived. This may involve setting up admission control criteria or data transmission criteria via parameters in beacon frames.

The processor may be configured to send an antenna selection request to the antenna unit or group of antenna units (or a second antenna unit or groups of antenna units) to implement the chosen antenna configuration; that is, which (if any) antennas are to operate on a first network, which (if any) are to operate on a second network and which (if any) are to enter an idle state. Alternatively, an antenna selection request may be sent to all the antenna units in the DAS, regardless of whether they need to change their operation.

After selecting an antenna unit or group of antenna units to operate on a first or second network the processor may send an antenna selection request to some or all of the affected antenna units in order to execute the selection, as required. That is, once the relevant antenna units have been selected to operate on a first or second network, an instruction may be sent by the controller to the relevant antennas to operate on the specific network allocated to them. The processor may be configured to send such an antenna selection request.

An antenna unit may comprise only a single antenna, operable on the first and any subsequent networks. Each antenna unit may comprise only a single antenna operable on the first and any subsequent networks.

Each antenna unit in the DAS may comprise an antenna. An antenna unit may comprise a single, or a plurality of (e.g. two, four, six etc) antennas.

When an antenna unit comprises only a single antenna and the antenna unit is operable on a first and second network, the antenna is configured to be able to operate on both a first and a second network. Thus a single antenna may be able to switch between operating on a first and second network.

When an antenna unit comprises a plurality of antennas and the antenna unit is operable on a first and second network, a first antenna may be configured to operate on a first network and a second antenna may be configured to operate on a second network. Thus when the antenna unit switches from operating on a first network to operating on a second network, an antenna operating on the first network may switch off (or enter an idle mode) and the antenna operating on the second network may switch on or activate. Alternatively, an antenna in an antenna unit comprising more than one antenna may be configured to be able to operate on both a first and second network, as in a single-antenna antenna unit.

Antenna units being part of a group of antenna units does not imply that the antenna units are collocated or close to each other. There may be no relationship between the locations of antennas making up a group of antenna units.

A plurality of antenna units located within the same geographic area may be referred to as a cluster of antenna units. A cluster of antenna units may behave as a single antenna unit i.e. all the antenna units in a specific cluster may always operate on the same network, or all be idle. This may simplify the control algorithms required to optimise coverage. Alternatively, antenna units within a cluster may be independent and may operate on different networks to other antenna units of the same cluster. In this latter case, a reference to a plurality of antenna units as a cluster simply refers to antenna units within a specific geographic area. Antenna units belonging to a cluster may share physical connections to base stations or hubs (such as cabling).

The term antenna unit may describe any device used to broadcast networks wirelessly. An antenna unit may comprise a transmitter, receiver and other standard components in order to enable it to function as described in the present disclosure. Such suitable devices would be readily derivable by a skilled reader and so will not be discussed further in the present disclosure.

Examples of devices comprising an antenna unit may include Wifi access points, base transceiver stations and eNodeBs.

The first network may be a WLAN, and a second network may be a cellular network.

In an embodiment the first network and where an antenna unit is further operable on a second network, the second network, are different wireless networks. The first and/or second network may be WLAN, 3G, 4G LTE, GSM, GPRS, EDGE or any other appropriate network as would be apparent to a skilled reader. The first network or second network may be a mobile network. The above list is not exhaustive.

The first network and where an antenna unit is further operable on a second network, the second network, may operate at different frequency bands. The first and/or second network may use any one or multiple of the following frequency bands: 166 MHz, 380 MHz, 410 MHz, 433 MHz, 450 MHz, 480 MHz, 700 MHz, 710 MHz, 750 MHz, 800 MHz, 810 MHz, 850 MHz, 900 MHz, 1.5 GHz, 1.7 GHz, 1.8 GHz, 1.9 GHz, 2.1 GHz, 2.3 GHz, 2.4 GHz, 2.5 GHz, 2.6 GHz, 3.5 GHz, 3.6 GHz, 4.9 GHz, 5 GHz, 5.9 GHz, 28 GHz and 60 GHz. The above list is not exhaustive. It is to be understood that wireless devices operate over a range of frequencies, rather than the fixed frequency as specified above. A nominal frequency value, as provided in the above list, is given as a representation of the frequency range.

As such, the processor may be configured to select an antenna unit or group of antenna units to operate at a first frequency band, based on the acquired traffic specification. The processor may be further configured to select a second (or subsequent) antenna unit or group of antenna units to operate at a second (or subsequent) frequency band.

The geo-location traffic specification may comprise at least one of a historic geo-location traffic specification and a short-term geo-location traffic specification.

The geo-location traffic specification may be either a historic geo-location traffic specification, or a short-term geo-location traffic specification.

Both historic geo-location traffic specifications and a short-term geo-location traffic specifications may comprise an indication of a location of a (or multiple) devices and a traffic requirement of a (or multiple) devices.

The geo-location traffic specification may comprise a historic geo-location traffic specification. A historic geo-location traffic specification may comprise historic geo-location traffic data. A historic geo-location traffic specification may be derived from historic geo-location traffic data. Historic geo-location traffic data may be geo-location traffic data sent by a device in the past and stored on a database.

A historic geo-location traffic specification may be a geo-location traffic specification from a period in the past that has been stored on a database. A historic geo-location traffic specification may use geo-location traffic data from the past that has been stored on a database. A historic geo-location traffic specification may be used to help estimate the current locations and requirements of devices using the DAS.

The controller, or a base station in which the controller is installed, may comprise an input for receiving a geo-location traffic specification from a database. The controller, or base station in which the controller is installed, may be connected to a database, wherein the database is for a storing historic geo-location requirement.

The processor may be configured to receive a geo-location traffic specification from a database. The database may be stored in the ‘cloud’, whereby the requirement is stored on remote servers and databases and access is achieved online.

Alternatively, the controller or a remote database may comprise a memory unit and a historic geo-location traffic specification may be stored on the memory unit. The processor may be configured to receive a historic geo-location traffic specification from the memory unit.

The historic geo-location traffic specification may be used instead of a short-term geo-location traffic specification, for example when a short-term geo-location traffic specification is unavailable, or when the DAS or controller is first started up and initiated. Alternatively, a historic geo-location traffic specification may be used to supplement a short-term geo-location traffic specification.

The geo-location traffic specification may comprise a short-term geo-location traffic specification. A short-term geo-location traffic specification may comprise or be derived from short-term geo-location traffic data.

Short-term geo-location traffic data may be geo-location traffic data that has not been stored in a database for a period of time. Short-term geo-location traffic data may be geo-location traffic data recently sent by a device. Short-term geo-location traffic data may be stored by an antenna unit. Short-term geo-location traffic data may be traffic data of devices using the DAS at the time when the geo-location traffic specification is received by the processor. Short-term geo-location traffic data may be used to provide a short-term geo-location traffic specification in substantially real-time; as such, short-term geo-location traffic data may be real-time geo-location traffic data. This may provide in a real-time geo-location traffic specification. A short-term geo-location traffic specification may be a real-time geo-location traffic specification, representing the location and traffic requirements of devices using the DAS in real time.

A short-term geo-location traffic specification may represent device traffic in substantially real-time and be updated in substantially real time.

A short-term geo-location traffic specification may be stored, accumulated or created by an antenna unit. A short-term geo-location traffic specification may be the cumulative locations and traffic requirements of devices using the DAS at the time when the geo-location traffic data is received by the processor.

The short-term geo-location traffic specification may comprise or be derived from short-term geo-location traffic data transmitted from a device to an antenna unit. The antenna unit may store short-term geo-location traffic data before sending it to the controller as a short-term geo-location traffic specification, or using it to make a short-term geo-location traffic specification which is sent to the controller.

The processor may be configured to send a traffic specification request to an antenna unit. The antenna unit may send the short-term geo-location traffic specification to the processor/controller in response to this traffic specification request. Optionally, the processor may be configured to send an acknowledgement to an antenna unit once the traffic specification has been received.

The controller may comprise an input for receiving the geo-location traffic specification from an antenna unit.

The processor may be configured to receive geo-location traffic data from an antenna unit, or to produce a geo-location traffic specification from geo-location traffic data received from an antenna unit.

A short-term geo-location traffic specification may be sent to a database to be stored and used in the future as, or to produce, a historic geo-location traffic specification.

The geo-location traffic specification may comprise or be derived from geo-location traffic data.

Geo-location traffic data may comprise Non-access stratum Attach requests and ADDTS.request and/or ADDTS.response.

The geo-location traffic specification may be derived from Non-access stratum Attach requests of a device using the DAS.

Some embodiments of geo-location traffic data (e.g. relating to a specific network) may only be receivable by antenna units operating on a particular network, e.g. ADDTS.request/response data can only be received by antenna units operating on a Wifi network. The above, and other suitable, signalling parameters are discussed in technical standards for the relevant technologies, for example IEEE Std 802.11-2012 for ADDTS parameters.

In some embodiments operable on a first and second network, if all the antenna units are operating on a first network, short-term or real-time geo-location traffic data for a second network may only be obtainable if one of the antenna units is able to operate on both the first and second networks simultaneously.

Furthermore, if all the antenna units are inactive or operating on a first network and none of the antenna units are operable on both the first and second network simultaneously, short-term geo-location traffic data may be unobtainable for the second network, as none of the active antenna units can receive geo-location traffic data for the second network while operating on the first network. In such scenarios an historic geo-location traffic specification may be used to determine a geo-location traffic specification for or including the second network.

An historic geo-location traffic specification may be used to determine an antenna unit configuration that is able to meet the geo-location traffic specification, even if a short-term geo-location traffic specification (and hence short-term geo-location traffic data) is available. This may allow a DAS with antenna units operating only on a first network to adapt or update to also provide coverage of a second network, even though geo-location traffic data for the second network could not be received by any of the antenna units (which were limited to the first network).

In embodiments in which an antenna unit is further operable at a second frequency band, defining a second network, one of the first and second network may be a cellular network. In embodiments in which an antenna unit is further operable at a second frequency band, defining a second network, one of the first and second network may be a 4G LTE network.

The geo-location traffic specification data may be derived from ADDTS data, e.g. ADDTS.request and/or ADDTS.response data, of a device using the DAS.

In embodiments in which an antenna unit is further operable at a second frequency band, defining a second network, one of the first and second network may be a WLAN. Other Traffic Specification (TSPEC) signalling parameters may be used in order to analyse location and traffic requirements.

Non-access stratum attach data and ADDTS data are two specific examples of geo-location traffic data. These may be sent by a device using the DAS and received by an antenna unit. The geo-location traffic data allows information regarding the traffic (and hence network requirements, including QoS specifications) and the location of the device (based on the antenna unit receiving the data) to be obtained.

The geo-location traffic data may be used to produce a geo-location traffic specification, which may be specific to the location of the antenna unit. Alternatively, a single, DAS-wide geo-location traffic specification may be produced and received by the controller. The geo-location traffic specification may be the accumulation of geo-location traffic data of devices using the DAS, as discussed above. Alternatively, a geo-location traffic specification may be a summary of the data. Alternatively, the data may be used to produce the geo-location traffic summary using an algorithm to extract pertinent information.

The above two exemplar embodiments of geo-location traffic data are not an exhaustive list. A number of methods and examples of obtaining geo-location traffic data exist. Many methods are defined in technical standards of the respective wireless network type.

Geo-location traffic data may comprise RIC-Request and RIC-signalling parameters. The use of such parameters is defined and discussed in technical standards, e.g. IEEE Std 802.11-2012.

Historic geo-location traffic data may comprise historic NAS (Non-access stratum) Attach requests from a device using the DAS and/or historic ADDTS.request and/or ADDTS.response data that is stored on a database.

An embodiment may be compatible with QoS-based traffic requests. As such, QoS-specific classifications such as User Priority for WLANs and QoS Class Identifiers in LTE systems may be taken into account and represented in the geo-location traffic specification. Meeting QoS-based requirements may be achieved by the antenna selection. Such QoS classifications may be handled and taken into account during antenna selection using methods known within the field to prioritise certain traffic which may be combined with or executed by embodiments of the present embodiment.

The processor may be configured to periodically cycle through a time slot, wherein the time slot comprises a first sub-slot in which the processor is configured to receive the geo-location traffic specification and a second sub-slot in which the processor is configured to select the antenna unit or group of antenna units to operate on the first network.

An embodiment may be implemented using a time slot which is periodically executed. The time slot may be of a fixed or variable length. The processor may be configured to execute the time slot.

The time slot may comprise a first sub-slot, a “traffic acquisition sub-slot”, during which the geo-location traffic specification is received. The geo-location traffic specification may be received by the processor from an antenna. A geo-location traffic specification may be received from all of the antennas. A geo-location traffic specification may be produced by the controller and received by the processor. The processor may be configured to produce a geo-location traffic specification.

The processor may be configured to send a traffic specification request to an (or every) antenna unit before, or at the beginning of, the traffic acquisition sub-slot. An (or every) antenna unit may send the short-term geo-location traffic specification to the processor/controller in response to this traffic specification request. In an embodiment this may comprise each antenna unit sending its ADDTS.request/ADDTS.response and/or NAS Attach Requests to the controller.

The processor may be configured to send a traffic specification request to a database before, or at the beginning of, the traffic acquisition sub-slot. The database may send a historic geo-location traffic specification to the processor/controller in response to this traffic specification request.

The processor may be configured to send a traffic specification request to both a database and an (or every) antenna unit before, or at the beginning of, the traffic acquisition sub-slot. The processor may be configured to first attempt to acquire a historic geo-location traffic specification from a database and then attempt to acquire a short-term geo-location traffic specification from antenna unit(s). This attempt may be in the form of sending a traffic specification request.

The processor may be configured to send an acknowledgement to the antenna unit(s) and/or database to confirm that the traffic specification has been received. The processor may be configured to send such an acknowledgement during the traffic acquisition sub-slot, or the subsequent antenna selection sub-slot.

The time slot may further comprise a second sub-slot, an “antenna selection sub-slot”, during which the processor may be configured to select the antenna unit or group of antenna units to operate on a first and/or further network.

The processor may be configured to determine and implement a specific antenna selection during the antenna selection sub-slot. During this sub-slot an, or multiple, antenna units or groups of antenna units may be selected to operate on a first or any subsequent network, based on the received geo-location traffic specification. The antenna selection may be such that the traffic requirement of the, or every device using the DAS, is met with respect to all networks, in the respective locations of the devices.

This may be done by producing a traffic estimate and selecting an antenna unit or group of antenna units to operate on the first or any subsequent network such that coverage of the respective network is provided. As such, the estimated traffic type may be transmitted and the geo-location traffic specifications fulfilled.

The processor may be configured to change the antennas that are operating on a first and/or a second network during the antenna selection sub-slot.

The processor may further send an antenna selection request to an antenna unit to implement the antenna selection during the antenna selection sub-slot. The antenna selection request may be sent to all the antenna units, to antenna units which are required to change their operation, or only to specific antenna units.

In the event that no geo-location traffic specification is received or acquired during the traffic acquisition sub-slot, the processor may be configured to select an antenna unit or groups of antenna units at random to operate on the first (and/or second) network.

Alternatively, in the event that no geo-location traffic specification is received or acquired during the traffic acquisition sub-slot, the processor may be configured to select no antenna unit or groups of antenna units to change to operate on the first (and/or second) network. Thus, the previous antenna unit configuration may be maintained.

An acknowledgement may be sent from an antenna unit that receives an antenna selection request to the processor once any necessary action has been completed by the antenna unit.

The time slot may further comprise a third sub-slot, wherein the processor is configured to permit a device using the DAS to transmit (and/or receive) data during the third sub-slot.

The time slot may further comprise a third sub-slot, a “data transmission sub-slot”, during which data is transmitted (and/or received) over the first and/or second and/or further network.

During the data transmission sub-slot, devices using the DAS may transmit and/or receive over the network(s).

It is not necessary to align the time slot with the time slot or frame structure in, for example, LTE cellular networks or Wifi networks (e.g. align with the timeslot of a Wifi's superframe).

The processor may be configured to set the length of the third sub-slot dependent on the traffic flow rate of devices using the DAS.

The length of the time slot may be reconfigured due to changes in traffic flow rate. The length of the data transmission sub-slot may be reconfigured due to changes in traffic flow rate.

The reconfiguration may optimise the trade-off between signalling overhead and data transmission to maximise efficiency.

The time duration of each sub-slot may be pre-determined, but may be reconfigured based on the calculation of a traffic flow rate.

The processor may be configured to check whether all devices have finished transmitting and/or receiving before ending the data transmission sub-slot. The processor may be configured to initiate the traffic acquisition sub-slot after the data transmission sub-slot is complete.

According to a further embodiment is a method for managing a distributed antenna system (DAS), the DAS comprising a plurality of antenna units, wherein each antenna unit is operable at a first frequency band, defining a first network;

the method comprising:
receiving a geo-location traffic specification;
   wherein a geo-location traffic specification comprises an indication of a location of a device using the DAS and a traffic requirement of the device;

the method further comprising
selecting an antenna unit or group of antenna units to operate on the first network, based on the received geo-location traffic specification; wherein
the antenna unit or group of antenna units is selected to meet the traffic requirement of the device with respect to the first network, in the location of the device.

An, or each, antenna unit may be further operable at a second frequency band, defining a second network.

Alternatively, the method may comprise: receiving geo-location traffic data of a device using the DAS; and selecting an antenna unit or group of antenna units to operate on the first network, based on the acquired traffic data. The antenna unit or group of antenna units may be selected to provide coverage of the first network for the device.

Alternatively, the antenna unit or group of antenna units may be selected to optimise network coverage for the device.

Further, the geo-location traffic specification may comprise an indication of a
location of a second device using the DAS and a traffic requirement of the second device; and the method may further comprise:
selecting a second antenna unit or second group of antenna units operable on the second network to operate on the second network, based on the received geo-location traffic specification; wherein the antenna unit or group of antenna units being selected to meet the traffic requirement of a second device using the DAS with respect to the second network, in the location of the second device.

The geo-location traffic specification may further comprise an indication of a location of a further device using the DAS and a traffic requirement of the further device; and
the method may further comprise selecting a further antenna unit or further group of antenna units to operate on the second network, based on the received geo-location traffic specification; wherein
the further antenna unit or further group of antenna units being selected to meet the traffic requirement of the further device using the DAS with respect to the second network, in the location of the further device. Thus, any number of groups of antennas may be selected to meet traffic requirements for any number of devices operating on any number of networks.

Alternatively, the method may further comprise: selecting a second antenna unit or second group of antenna units to operate on the second network, based on the received geo-location traffic specification; wherein the second antenna unit or second group of antenna units is selected to meet second network requirements of the geo-location traffic specification.

Alternatively, the method may further comprise: selecting a second antenna unit or second group of antenna units to operate on the second network, based on the acquired traffic data. The second antenna unit or second group of antenna units may be selected to provide coverage of the second network for devices using the DAS.

The antenna unit may comprise only a single antenna, operable on the first and second networks. Each antenna unit may comprise only a single antenna, operable on the first and second networks.

The geo-location traffic specification may comprise a historic geo-location traffic specification.

The geo-location traffic specification may comprise a short-term geo-location traffic specification.

One of the first and second network may be a cellular network, e.g. 4G LTE network. One of the first and second network may be a mobile network.

The geo-location traffic specification may comprise or be derived from Non-access stratum Attach requests of a device using the DAS.

One of the first and second network may be a WLAN.

The geo-location traffic specification data may comprise or be be derived from ADDTS.request and/or ADDTS.response data of a device using the DAS.

Other Traffic Specification (TSPEC) status and statistics may be used in order to analyse location and traffic requirements.

Other QoS-based traffic specification signalling parameters may be used to obtain geo-location traffic data.

The method may further comprise: periodically cycling through a time slot, wherein the time slot comprises a first sub-slot in which the processor is configured to receive the geo-location traffic specification and a second sub-slot in which the processor is configured to select the antenna unit or group of antenna units to operate on the first network

The time slot may further comprise a third sub-slot in which a device using the DAS transmits and/or receives data over the DAS.

The length of the third sub-slot may be variable depending on the traffic flow rate of devices using the DAS. The length of the third sub-slot may be dependent on the traffic flow rate of devices using the DAS.

Discussion, above, in relation to a controller according to an embodiment applies, mutatis mutandis, to a method according to an embodiment. Features relating to the configuration of the processor and, in particular, operations that the processor is configured to carry out apply, mutatis mutandis, to a method according to an embodiment. A method for which a processor according to an embodiment is configured to execute, may be according to an embodiment.

According to a further embodiment is a distributed antenna system (DAS) for providing coverage of a first frequency band, defining a first network; the DAS comprising:
a plurality of antenna units, each operable on the first network; and
a controller operably connected to the antenna units, the controller comprising a processor;
wherein the processor is configured to:
   receive a geo-location traffic specification;
      wherein a geo-location traffic specification comprises an indication of a location of a device using the DAS and a traffic requirement of the device;
the processor further being configured to:
   select an antenna unit or group of antenna units to operate on the first network, based on the acquired traffic specification;
   wherein the antenna unit or group of antenna units is selected to meet the traffic requirement of the device with respect to the first network, in the location of the device.

The DAS may additionally be for providing coverage of a second network.

Each antenna unit may be further operable at a second frequency band, defining a second network.

According to a further embodiment is a distributed antenna system (DAS) for providing coverage of a first frequency band, defining a first network; and a second frequency band, defining a second network; the DAS comprising:
a plurality of antenna units, each operable on the first network and the second network; and
a controller operably connected to the antenna units, the controller comprising a processor;
wherein the processor is configured to:
   receive a geo-location traffic specification;
      wherein a geo-location traffic specification comprises an indication of a location of a device using the DAS and a traffic requirement of the device;
the processor further being configured to:
   select an antenna unit or group of antenna units to operate on the first network, based on the acquired traffic specification;
   wherein the antenna unit or group of antenna units is selected to meet the traffic requirement of the device with respect to the first network, in the location of the device.

The geo-location traffic specification may further comprise an indication of a location of a second device using the DAS and a traffic requirement of the second device; and
the processor may further be configured to select a second antenna unit or second group of antenna units to operate on the second network, based on the received geo-location traffic specification; wherein
the second antenna unit or second group of antenna units is selected to meet the traffic requirement of the second device using the DAS with respect to the second network, in the location of the second device.

The DAS may additionally be for providing coverage of a further network.

Each antenna unit may be further operable at a further frequency band, defining a further network.

The geo-location traffic specification may further comprise an indication of a location of a further device using the DAS and a traffic requirement of the further device; and
the processor may further be configured to select a further antenna unit or further group of antenna units to operate on the further network, based on the received geo-location traffic specification; wherein
the further antenna unit or further group of antenna units is selected to meet the traffic requirement of the further device using the DAS with respect to the further network, in the location of the further device. Thus, any number of groups of antennas may be selected to meet traffic requirements for any number of devices operating on any number of networks.

Alternatively, the processor may be configured to: receive geo-location traffic data of a device using the DAS; and select an antenna unit or group of antenna units to operate on the first network, based on the acquired traffic data. The antenna unit or group of antenna units may be selected to provide coverage of the first network for the device.

Alternatively, the antenna unit or group of antenna units may be selected to optimise network coverage for the device.

An antenna unit may comprise only a single antenna, operable on the first network and a second or further network. Each antenna unit may comprise only a single antenna, operable on the first network and a second or further (and any subsequent) network.

A controller provided in the DAS may be a controller according to an embodiment as discussed above.

The DAS may further comprise:
a hub connecting the controller to at least one of the antenna units; and/or
a database operably connected to the controller, the database storing a historic geo-location traffic specification.

A distributed antenna system (DAS) may be a distributed antenna apparatus.

A DAS may comprise a hub connecting the controller to at least one of the antenna units.

A DAS may comprise a database operably connected to the base station, the database storing a historic geo-location traffic specification.

Discussion of features in relation to a controller or method according to an embodiment applies, mutatis mutandis, to a DAS according to an embodiment.

According to a further embodiment is a computer readable carrier medium carrying computer executable instructions which, when executed on a processor, cause the processor to carry out a method according to an embodiment.

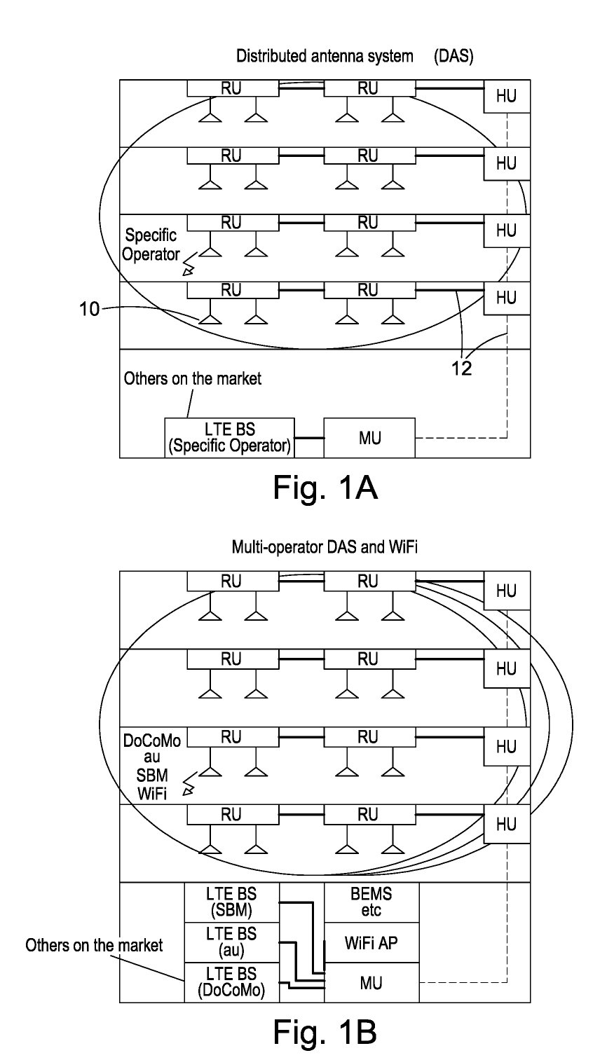

Turning now to the figures, FIGS. 1A and 1B schematically illustrate known distributed antenna systems. Such a DAS may be installed in an office or shopping centre. In the illustrated DAS a central control master unit (MU) is connected to the antenna units 10—normally by optical cable 12—via the hub unit (HU). Each antenna unit 10 or group of antenna units 10 can be modelled as a radio remote unit (RU). The RU can operate on a single network, as illustrated in FIG. 1A, or multiple networks as illustrated in FIG. 1B. When operating on multiple networks such as in FIG. 1B, each RU comprises two antennas, each antenna being dedicated to a single network. This produces multiple substantially collocated networks as shown in FIG. 1B. The operation of these RUs does not vary over time.

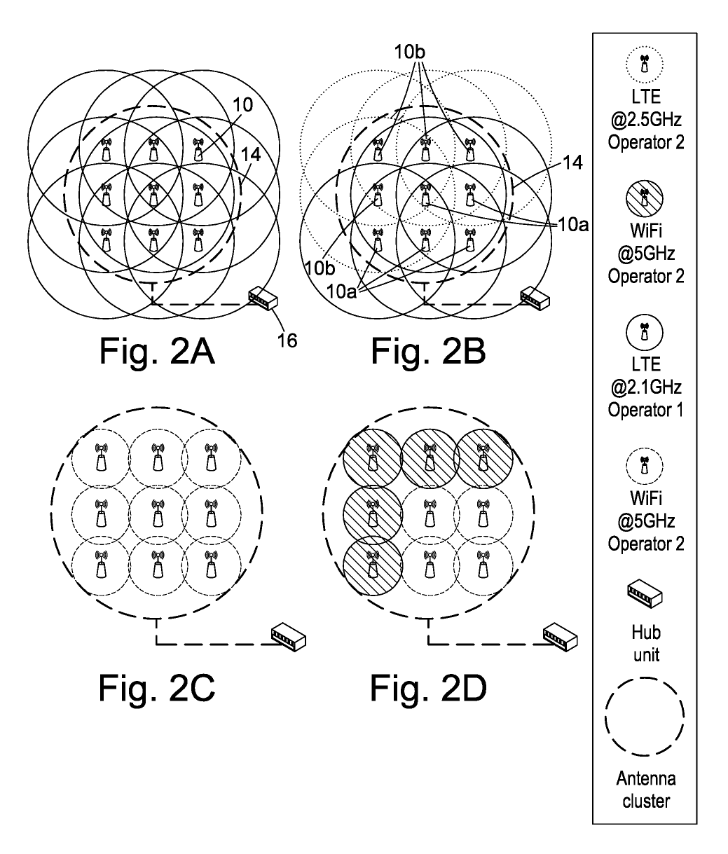

FIGS. 2A and 2B illustrate further distributed antenna systems according to the prior art. In FIG. 2A a plurality of antennas or antenna units 10 are located in an antenna unit cluster 14 which covers a specific geographic area. All of the antennas 10 are connected to a hub 16. All of the antennas 10 of FIG. 2A are operating on the LTE network (which is being used as an example of a cellular network) at 2.1 GHz provided by operator 1. In FIG. 2B, which depicts a different DAS, a similar arrangement of antennas 10 is illustrated. However, in FIG. 2B, five of the antennas 10a are operating on the LTE network at 2.1 GHz, provided by operator 1 and four antennas 10b are operating on the LTE network at 2.5 GHz, provided by operator 2. The antenna 10 configuration is predefined and each antenna is dedicated to operating on only one of the two networks. As such, the network coverage does not vary over time or in response to traffic load. This can lead to the DAS being inefficient.

FIGS. 2C and 2D illustrate distributed antenna systems similar to those illustrated in FIGS. 2A and 2B. In FIG. 2C all the antennas 10 are operating on Wifi provided by operator 1, whereas in FIG. 2D, which depicts a different DAS, four of the antennas are operating on Wifi provided by operator 1 and five of the antennas are operating on Wifi provided by operator 2. The similar restraints apply to the DAS of FIG. 2D as to that of FIG. 2B—each antenna 10 is preconfigured to operate on only one network.

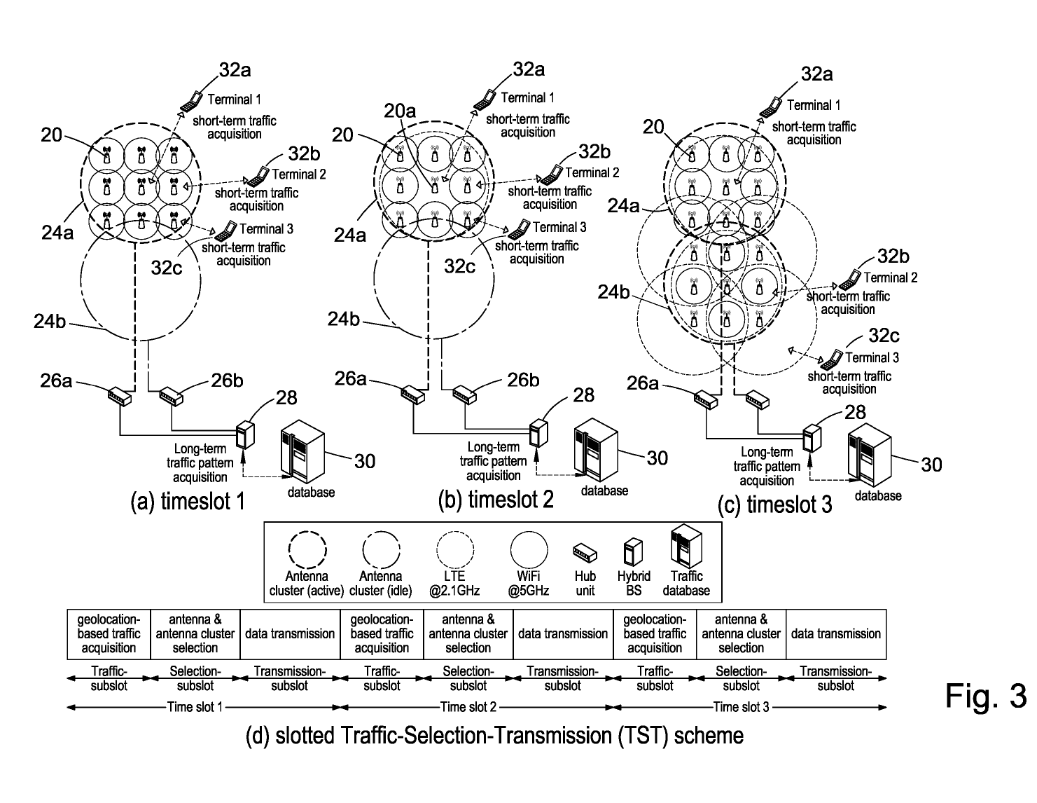

FIG. 3 illustrates a DAS according to an embodiment of the present disclosure. The DAS is illustrated in three different operational configurations in three different time slots. The DAS comprises a plurality of antenna units 20 grouped into two different clusters 24a, 24b. Each cluster 24 is associated with a hub unit 26. A cluster 24 of antenna units 20 simply describes a plurality of antenna units within a certain geographical area connected to a common hub. The operation of antenna units 20 within a cluster is independent. Inactive antenna units 20 are not illustrated. Each antenna unit of the present embodiment is operable on a first and a second network (Wifi at 5 GHz and LTE at 2.1 GHz) Each antenna unit 20 is connected to the hub unit 26, for example by optical cable. Each hub unit 26 is connected to a single hybrid base station 28 which comprises, or is an example of, a controller according to an embodiment. The controller undertakes the method of the present disclosure. As well as being connected to the hubs 26, the base station 28 of the present embodiment is connected to a database 30. The database 30 stores an historic geo-location traffic specification. In other embodiments, the DAS may not comprise a database 30. Three devices, labelled as terminals 32 and illustrated as mobile phones in the present embodiment, are operating within the DAS.

The DAS of FIG. 3 uses geo-location traffic data to monitor traffic load and provide a geo-location traffic specification. The geo-location traffic specification comprises an LTE network specification and a Wifi network specification. The geo-location traffic specification is used to configure the antenna units 20 to meet the traffic requirements of the, or each device with respect to the first and second network, in the location of the device(s). This is achieved by selecting a first antenna unit or group of antenna units to operate on a first network. These antenna units provide sufficient coverage to meet the first network requirements of devices in their respective locations. A second antenna unit or group of antenna units may be selected to operate on a second network. These antenna units provide sufficient coverage to meet the second network requirements of devices in their respective locations. These selections are based on the acquired geo-location traffic specification. This traffic specification is be derived from short-term geo-location traffic data received from the antenna units 20, historic geo-location traffic data from the database 30, or both. Alternatively, the traffic specification may comprise a short-term geo-location traffic specification received from the antenna units 20, a shitoric geo-location traffic specification from the database 30, or both.

In the embodiment of FIG. 3 the DAS is configured to operate on two networks: LTE (used as an example of a cellular network) at 2.1 GHz and Wifi at 5 GHz. A DAS according to an embodiment of the present disclosure may, however, be configured to operate on more than two networks and with any network suitable for DAS operation.

Each of the antenna units of FIG. 3 is able to switch between operating on the first network and the second network. Each antenna unit is therefore configured such that it can operate on and provide coverage of a first network (e.g. Wifi) during a first time slot and a second network (e.g. LTE) during a second time slot. In some embodiments, however, only a limited number of antenna units (e.g. one) may be configured such that it can operate on and switch between a first network and a second network.

The terminals 32 are devices using the DAS. The terminals are illustrated as mobile phones capable of using LTE and Wifi, but represent any device or number of devices that contribute to traffic load on at least one of the networks, such as a “station” (STA) e.g. a laptop, operating on the Wifi network, or user equipment (UE) operating on the LTE network. Naturally, in most applications a larger number of terminals will be active and monitored at a time. The terminals 32 are mobile, and so are free to move around within the geographic extent of the DAS. In the present embodiment, the base station 28 periodically receives a short-term geo-location traffic specification from the antenna units 20.

The geo-location traffic specification is produced from, and using, geo-location traffic data. Geo-location traffic data in the present embodiment comprises existing signalling protocols, for example ‘NAS Attach request’ parameters to analyse the location and traffic requirement from UEs on a LTE network and ADDTS.request/response signalling for Wifi methods, discussed in detail in the relevant technical standard e.g. IEEE Std 802.11-2012. QoS signalling parameters are taken into account and factored in to the geo-location traffic specification. Other signalling techniques may also be suitable for use with the present embodiment.

In the present embodiment, the geo-location traffic data, received from the terminals 32 using the DAS, is stored in the antenna units 20. This geo-location traffic data is collected, accumulated and periodically sent to the base station 28 as a geo-location traffic specification. This geo-location traffic specification enables the base station 28 to reconfigure the antenna units 20 in order to meet the short-term traffic requirements in specific locations. In the present embodiment the geo-location traffic data is received in substantial real-time. As such, the short-term geo-location traffic specification is substantially a real-time geo-location traffic specification.

In the embodiment of FIG. 3, the base station 28 also receives a historic geo-location traffic specification from the database 30. This is a geo-location traffic specification from the past, which can be used as an estimate of a real-time traffic specification.

In time slot 1 of FIG. 3 the terminals 1, 2 and 3 (32a, 32b, 32c) are all operating on the Wifi network within the geographic area covered by the first cluster 24a. During this time slot, all of the antenna units 20 of cluster 1 are operating on the Wifi network, and so are providing Wifi network coverage. There is no demand for the LTE network at this time and so none of the antenna units 20 are dedicated to providing LTE network coverage. Furthermore, the entire traffic load during time slot 1 is located within the geographic area of the first cluster 24a, so the second cluster 24b is not activated, i.e. none of the antenna units 20 of the second cluster 24b are operating on either network. In some embodiments, an inactive cluster (i.e. one that is not required to provide network coverage) may go into a low power mode, be deactivated, turned off or continue to operate on one or multiple networks.

During time slot 2, terminal 1 (32a) requires coverage of the LTE network. The locations of terminals 1, 2 and 3 have not changed from those of time slot 1.

The base station 28, having received a geo-location traffic specification from the antenna units 20 of both clusters 24a 24b and database 30 during a traffic acquisition sub-slot of time slot 2, determines an antenna unit 20 configuration that is able to meet the geo-location traffic specification. In order to do this, the DAS must provide LTE network coverage for terminal 1 (32a), while still providing Wifi coverage for terminals 2 and 3 (32b, 32c). The base station 28 selects the centre antenna unit 20 of the first cluster 24a to operate on the LTE network, switching it from the Wifi network. This meets the LTE network requirement in the respective location, reflected in the geo-location traffic specification.

In some embodiments, if all of the antenna units are operating on a first network, geo-location traffic data for a second network may only be obtainable by an antenna unit if one of the antenna units is able to operate on both the first and second networks.

A historic geo-location traffic specification may be used to determine an antenna unit configuration that is able to meet the geo-location traffic specification, even if a short-term geo-location traffic specification (and hence short-term geo-location traffic data) is available. This may allow a DAS with antenna units operating only on a first network to adapt or update to also provide coverage of a second network in order to meet a traffic requirement for the second network, even though short-term or real-time geo-location traffic data for the second network could not be received by any of the antenna units (which were limited to operating on the first network).

Once the antenna units and networks have been selected, the antenna units implement the selection accordingly. This configuration therefore provides coverage of both networks for the terminals 32 using the DAS. Thus coverage is optimised. This is done during an antenna and antenna selection sub-slot of time slot 2.

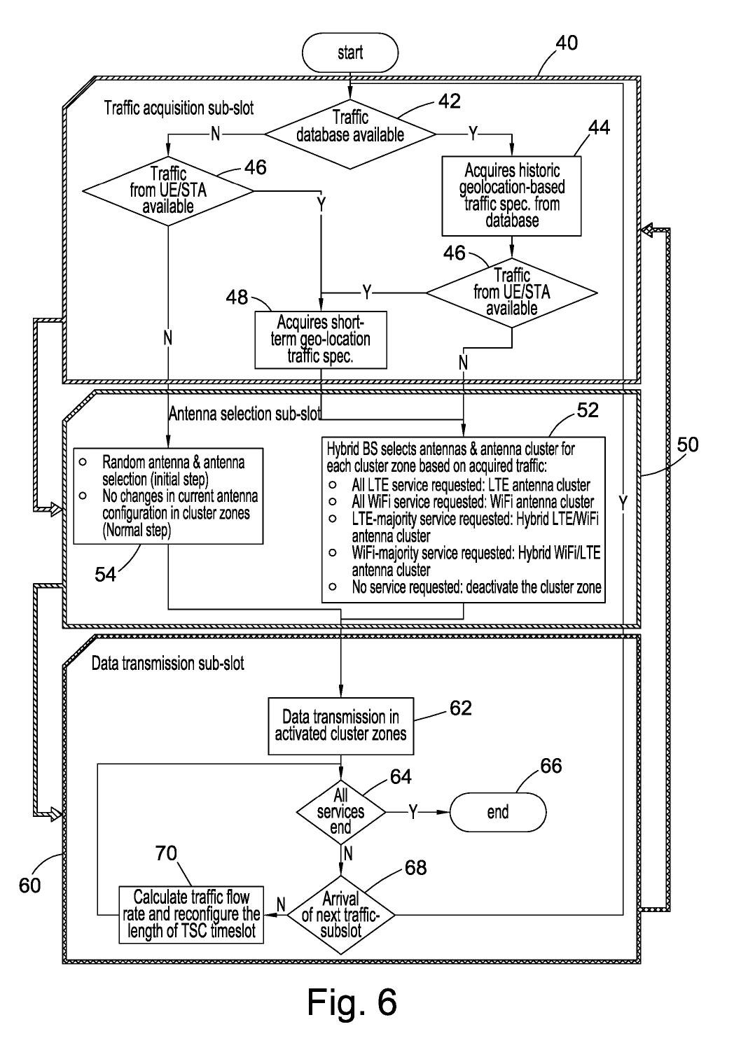

The terminals 32 then transmit and/or receive over the DAS during a third, data transmission, sub-slot. Although the present embodiment utilises the above so-called traffic-selection-transmission time slot scheme (described in more detail with reference to FIG. 6) there are other schemes that would be suitable for implementing embodiments of the present disclosure, which is not felt to be limited to the scheme described herein.

In the above example, the antenna selection and hence configuration is based on a short-term geo-location traffic specification. If, for some reason, short-term traffic data is not available and so a short-term geo-location traffic specification is not available, the selection is made based on the historic geo-location traffic specification received from the database. In some embodiments, however, the antenna selection may preferably be based on a combination of both types of geo-location traffic specification.

If a short-term geo-location requirement is not available and a historic geo-location traffic specification is not available from the traffic load database 30, but an antenna unit or a group of antenna units has previously been selected to operate on a first and/or second network, then the controller will maintain the current antenna unit configuration. If a short-term geo-location traffic specification is not available, historic data is not available and no antenna units have previously been selected to operate on either of a first or second network (e.g. it is the initial step in starting the DAS) the base station of the present embodiment will randomly select antenna units to operate on a first network and/or a second network.

Looking now at time slot 3, terminal 1 (32a) is unchanged from time slot 2, terminal 2 (32b) has now moved location to be within the geographic area of the second antenna unit cluster 24b and is using the Wifi network and terminal 3 (32c) is using the LTE network within range of the second cluster 24b.

The terminals 32a, 32b, 32c transmit geo-location traffic data to the antenna units 20. The antenna units 20 then transmit a geo-location traffic specification to the base station 28. The base station 28, after receiving a geo-location traffic specification, configures the antenna units 20 by selecting an antenna unit or group of antenna units to operate on a first and second network, such that the LTE and Wifi network requirements are met and all the terminals 20 are provided with coverage and are able to transmit and/or receive on their chosen network. This involves activating the second cluster 24b and configuring the antenna units 20 therein such that Wifi coverage is provided for terminal 2 (32b) and LTE coverage is provided for terminal 3 (32c). As the configuration of the first cluster 24a during the time slot 2 provides sufficient coverage for the transmission requirements in time slot 3, the configuration of the first cluster does not change between time slot 2 and time slot 3. In other embodiments, however, the configuration of antenna units 20 in cluster 3 may change now that they no longer need to provide coverage for terminals 2 and 3 in order to minimise power output.

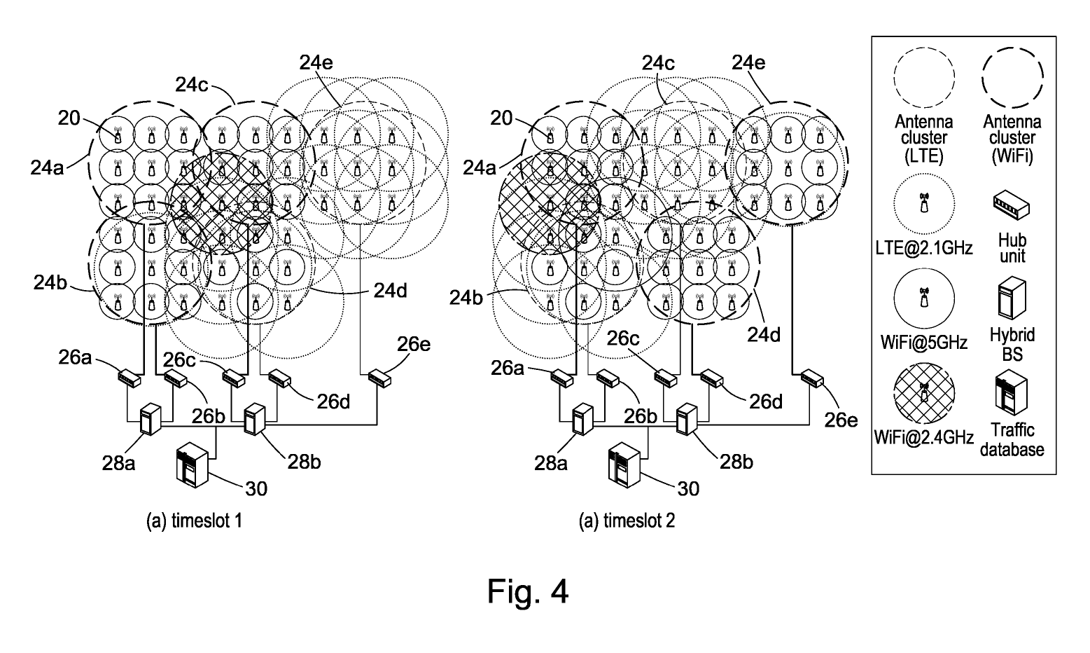

FIG. 4 illustrates a further DAS according to an embodiment in a first time slot and a second time slot. The DAS of FIG. 4 comprises five clusters 24 of antenna units 20, each cluster 24 connected to a hub unit 26 as in FIG. 3. The first two clusters 24a, 24b are connected to a first base station 28a and the third, fourth and fifth clusters 24c, 24d, 24e are connected to a second base station 28b. The two base stations 28 are connected to each other, as well as to a traffic load database 30. Each base station 28 may comprise a controller and be capable of communicating with the other base station to coordinate their behaviour.

The DAS of FIG. 4 operates in a similar manner to that of FIG. 3, with each base station 28 acquiring a geo-location traffic specification originating from devices operating on networks on the DAS, or from the shared traffic database 30. The base stations 28 then select antenna units or a group of antenna units to operate on a first (and subsequent) network and implement this selection via the hub 26. In the embodiment of FIG. 4, however, each antenna unit is configured to be able to operate and provide coverage of three networks: LTE at 2.1 GHz, Wifi at 5 Ghz and Wifi at 2.4 Ghz. Furthermore, two base stations are collectively responsible for antenna selection. In FIG. 4, the two base stations coordinate with each other in order to select antenna units to operate on the first, second or third networks across the entire DAS such that network coverage for devices using the DAS is provided and optimised.

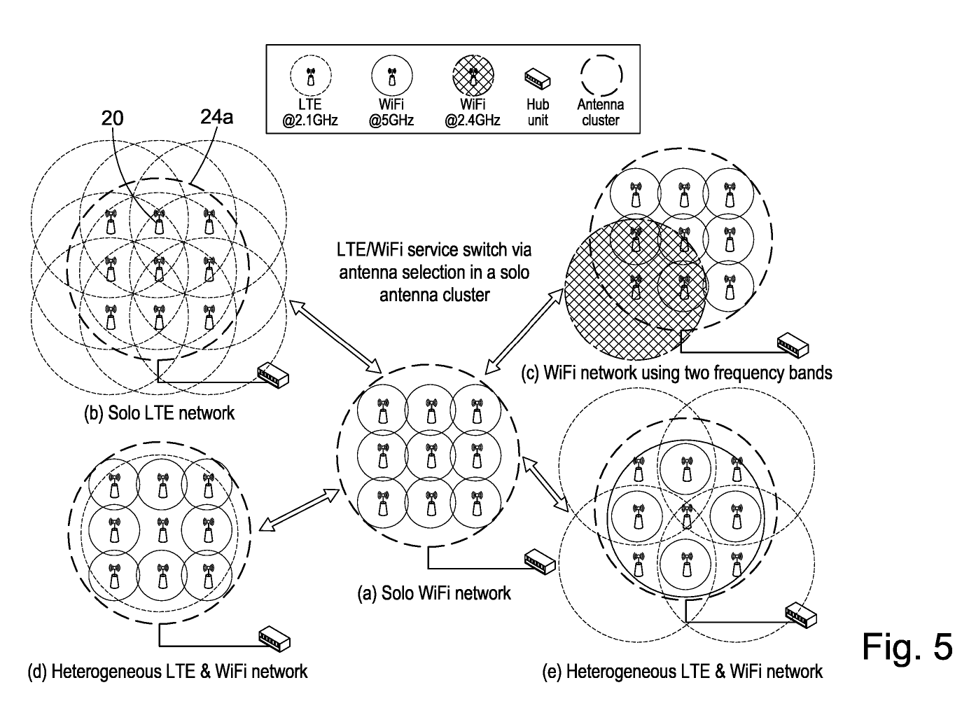

FIG. 5 illustrates example configurations of a cluster 24 of antenna units 20, each being operable on three networks, and how the cluster 24 is able to switch between these configurations by selecting different antenna units or groups of antenna units to operate on one of the three networks. Any cluster 24 as illustrated in FIG. 5 could be implemented into a DAS according to any of the embodiments described herein.

FIG. 6 is a flow diagram illustrating a method according to an embodiment for implementing the above system or for running on a controller according to an embodiment. The method comprises the periodical execution of a traffic-selection-transmission (TST) time slot. Antenna units can be selected—and hence the cluster and antenna configuration (antenna selection) can change—each time the TST time slot is executed. This arrangement therefore provides a great deal of flexibility, allowing the DAS to frequently adapt to provide (optimised) coverage based on short-term traffic data received from devices active over the DAS.

The TST time slot of FIG. 6 comprises three sub-slots: a traffic acquisition sub-slot 40, an antenna unit or groups of antenna units selection sub-slot (“antenna selection sub-slot”) 50 and a data transmission sub-slot 60. The first sub-slot is the traffic acquisition sub-slot 40. During the traffic acquisition sub-slot 40, the controller (often a base station) receives a geo-location traffic specification. The second sub-slot is the antenna selection sub-slot 50. During the antenna selection sub-slot 50, the controller selects antenna units or groups of antenna units to operate on a first network. The controller may also select antenna units or groups of antenna units to operate on a second, third, fourth or n^{th} network. The antenna selection may be implemented during the antenna selection sub-slot 50. As such, an optimal antenna unit configuration is determined during the antenna selection sub-slot 50. The third sub-slot is the data transmission sub-slot 60. During the data transmission sub-slot 60, devices operating on the DAS transmit and/or receive data over the networks. The data transmission sub-slot 60 may also comprise a monitoring step whereby the length of the data transmission sub-slot 60 can be altered if the traffic flow rate indicates. After the data transmission sub-slot 60 is complete, a traffic sub-slot 40 is initiated.

As discussed above, the TST time slot starts with the traffic acquisition sub-slot 40. Upon initiation of the traffic acquisition sub-slot 40 the traffic database is checked 42 to see if it is available i.e. if a historic geo-location traffic specification can be acquired therefrom. If the traffic database is available, the controller receives a historic geo-location traffic specification from the database 44. Once the historic geo-location traffic specification has been received, or if the database is unavailable, the controller checks whether short-term traffic from the devices (e.g. UE/STA in the embodiment of FIG. 6) operating on the DAS is available 46. As such, the controller attempts to receive a short-term geo-location traffic specification from the antenna units, based on geo-location traffic data received from devices operating on the DAS, regardless of the availability of traffic from the database. If traffic from a UE/STA is available, a short-term geo-location traffic specification is acquired or derived therefrom 48.

The selection sub-slot 50 follows the traffic acquisition sub-slot 40. If at least one type of geo-location traffic specification has been acquired—that is, if a historic geo-location traffic specification from the database, a short-term geo-location traffic specification from the UE/STA or both has been acquired, the controller selects antenna units to operate on a first network based on the received traffic specification 52. In the embodiment of FIG. 6 the hybrid BS selects an antenna unit or group of antenna units to operate on a first network, based on the received geo-location traffic specification. The hybrid BS may select a further, or multiple further, antenna units or groups of antenna units to operate on a second, third or further network, based on the acquired geo-location traffic specification. Antenna units may be selected to meet the traffic requirements of the or each represented device with respect to the first and subsequent networks, in the location of the device(s), respectively.

In the present embodiment, the hybrid BS differentiates between the following situations and selects antenna units for certain networks in a cluster accordingly: all LTE service requested—LTE antenna unit cluster; all Wifi service requested—Wifi antenna unit cluster; LTE-majority service requested—hybrid LTE/Wifi antenna unit cluster; Wifi-majority service requested—hybrid Wifi/LTE antenna unit cluster; no service requested—deactivate the cluster zone. The antenna units or groups of antenna units are selected such that coverage of the first (and second etc) network is provided for a device using the DAS.

If no geo-location traffic data (and hence no geo-location traffic specification—historic or immediate geo-location based) has been received, the hybrid BS must configure the antenna units without the use of any traffic data 54. If the present TST time slot is the initial time slot (e.g. the DAS is just being initialised and no antenna units are active on any network), then the hybrid BS randomly selects antenna units to operate on a first, second, etc network. If the present TST time slot is not the initial slot, no changes are made to the current antenna unit configuration (i.e. no antenna units switch network, activate, or deactivate).

The data transmission sub-slot 60 is the third sub-slot. After the antenna units have been configured in the selection sub-slot 50, the data transmission sub-slot 60 begins. During the data transmission sub-slot 60, data is transmitted and/or received over the antenna units in the active cluster zones 62. A decision 64 then determines if all services have ended. If so, the process ends 66. If not, and devices are still active over the DAS, a further decision 68 is taken to ascertain whether the next traffic sub-slot 40 has arrived.

If the next traffic acquisition sub-slot 40 has arrived, the traffic acquisition sub-slot 40 is initiated again and the availability of the traffic database is checked 42. If the next traffic acquisition sub-slot 40 has not arrived, the traffic flow rate is calculated and the length of the data transmission sub-slot 60 is reconfigured 70. This reconfiguration of the length of the sub-slot 70 may not occur during every iteration of the time slot. The reconfiguration may optimise the trade-off between signalling overhead and data transmission to maximise efficiency. The reconfiguration step 70 may be omitted in certain embodiments.

After a reconfiguration step 70 is taken, the decision 64 as to whether all services have ended is executed.

The time duration of each sub-slot is pre-determined, but can be reconfigured based on the calculation of traffic flow rate 70. For example, if all services have not finished at the end of the data transmission sub-slot 60, the next traffic acquisition sub-slot 40 will start and data transmission will be suspended. Only if all data transmission is complete will a new traffic acquisition sub-slot 40 not start after a data transmission sub-slot.

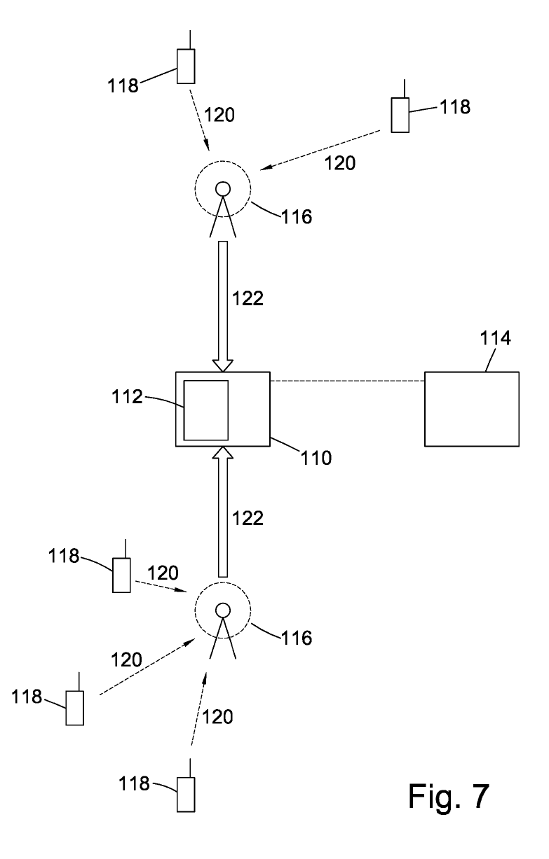

FIG. 7 schematically illustrates DAS according to an embodiment comprising a controller 110. The controller 110 comprises a processor 112 according to an embodiment. The controller 110 is operably connected to a database 114, from which it may receive historic geo-location traffic specifications. The DAS is illustrated as comprising two antenna units 116. Five devices 118 are using the DAS.

Each device 118 sends geo-location traffic data 120 to an antenna unit 116. This geo-location traffic data 120 may be sent periodically, or only when a device 118 moves from the location of one antenna unit 116 to another. This geo-location traffic data may be NAS Attach requests or ADDTS signalling parameters, such as ADDTS.request and ADDTS.response.

The antenna units 116 collect the received geo-location traffic data 120 (i.e. short-term geo-location traffic data) and transmit the collected geo-location traffic data to the processor 112 of the controller 110 as a short-term geo-location traffic specification 122. Each antenna unit 116 transmits this geo-location traffic specification 122 periodically during the traffic acquisition sub-slot of the periodical time slot. The controller 110 also receives a historic geo-location traffic specification from the database 114.

The short-term geo-location traffic specification may also be received by the database 114, in order to store for potential future use as a historic geo-location traffic specification.

The controller 110 uses the geo-location traffic specification 122 received from each antenna unit 116 to select antenna units 116 to operate on each network, such that the geo-location network requirement for that network are met in the relevant locations.

In the absence of any short-term geo-location traffic data 120 the antenna units 116 are unable to provide a short-term geo-location traffic specification 122. The controller 110 may then use a historic geo-location traffic specification, received from the database 114, to select antenna units 116 to operate on each network.

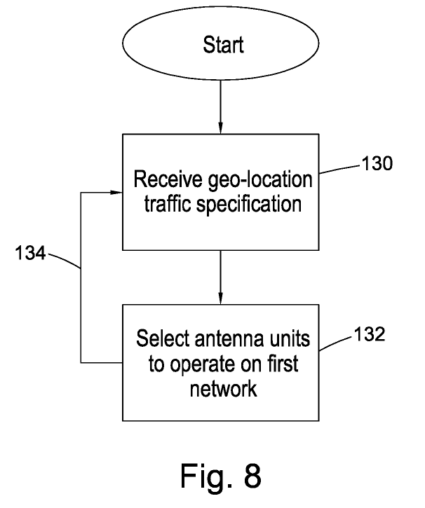

FIG. 8 is a flow diagram illustrating a method according to an embodiment. The method is for managing a distributed antenna system (DAS), the DAS comprising a plurality of antenna units, wherein each antenna unit is operable at a first frequency band, defining a first network.

The method comprises receiving a geo-location traffic specification 130. This geo-location traffic specification comprises an indication of a location of a device using the DAS and a traffic requirement of the device. Antenna units are then selected to operate on the first network 132. The selection is made based on the received geo-location traffic specification and the antenna unit or group of antenna units is selected to meet the traffic requirement of the device with respect to the first network, in the location of the device.

Further iterations of the method may be implemented 134. The method may be implemented periodically, and may comprise further steps whereby a second or subsequent antenna is selected to operate on a second or subsequent network.

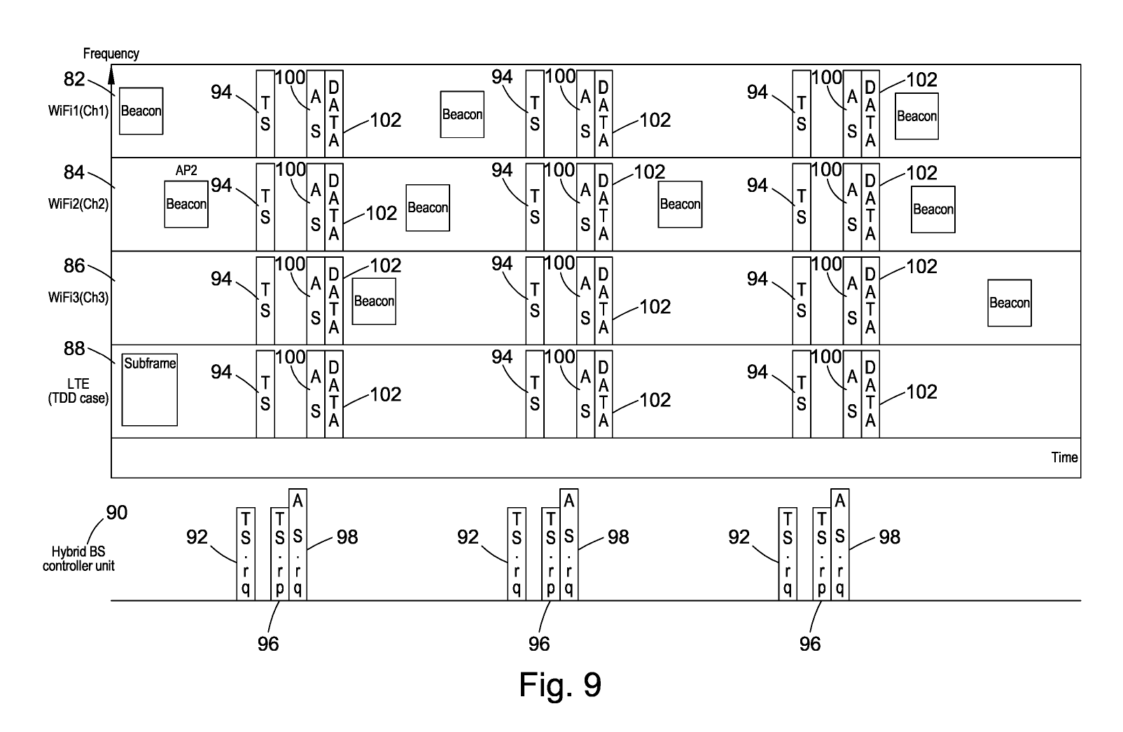

FIG. 9 schematically illustrates an implementation of a time slot according to an embodiment.

The horizontal bands 82, 84, 86, 88 are different networks and are, in this embodiment, Wifi1 82, Wifi2 84, Wifi3 86 and an LTE network 88. The different networks operate in different frequency bands. The x axis represents time. The figure also illustrates the operations of a hybrid BS controller unit 90, comprising a controller according to an embodiment.

Periodic beacon slots are illustrated for each Wifi network. The time between beacon slots in each Wifi network 82, 84, 86 is different.

The controller unit 90 sends out a traffic specification request during “TS.rq” 92 to all the antenna units providing the four networks. In response to this, every antenna unit replies with a geo-location traffic specification during “TS” 94. This traffic specification 94 comprises geo-location traffic data. In the present embodiment, antenna units operating on the three WiFi channels 82, 84, 86 reply with ADDTS data and antenna units operating on the LTE network 88 reply with NAS Attach Requests. In alternative embodiments, antenna units may reply with a geo-location traffic specification derived from, but not including, this geo-location traffic data.

The controller unit 90 sends a traffic specification response during “TS.rp” 96 to acknowledge receipt of the geo-location traffic specification 94. Once the traffic specification 94 has been received, a decision is made on antenna selection whereby antenna units or groups of antenna units are selected to operate on the first, second or subsequent network, respectively. An antenna selection request is sent during “AS.rq” 98 to all antenna units, or all antenna units affected by the antenna selection. This request contains instructions on which antenna units need to operate on which network.

Antenna units in receipt of the antenna selection request implement the antenna selection during “AS” 100. This implementation may require an antenna unit to change from operating on a first network to second network, or to enter or leave an idle mode.

Once the antenna selection has been implemented, devices transmit and/or receive data over the network during “DATA” 102.

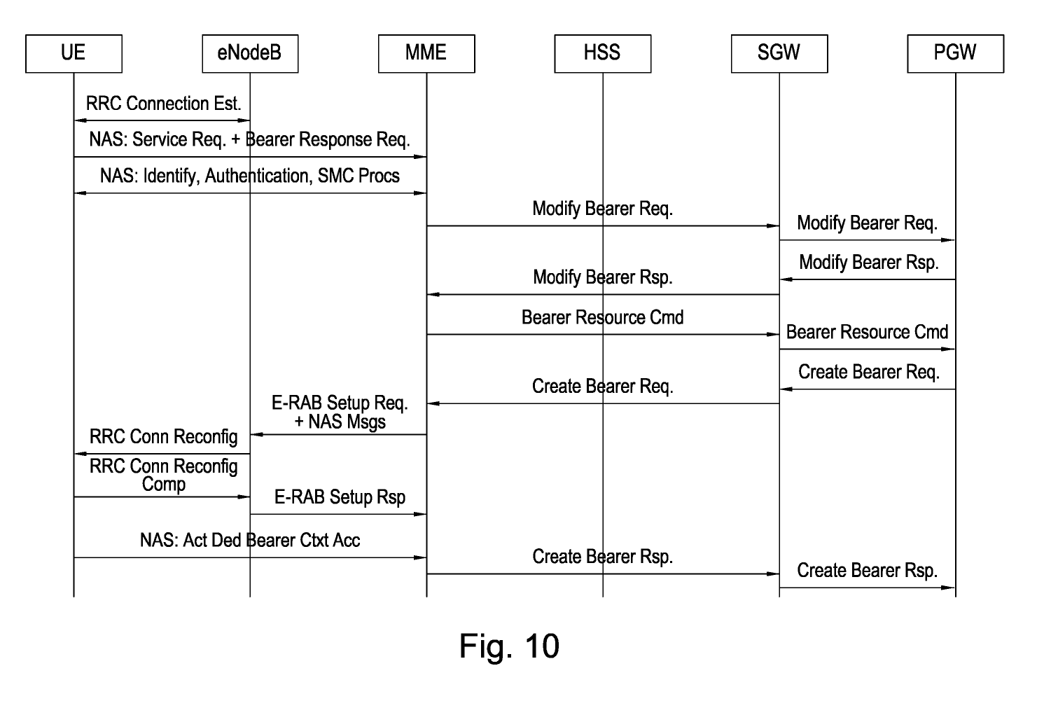

FIG. 10 schematically illustrates communication between subcomponents of the system architecture evolution of 3GPP's LTE wireless communication standard. The figure illustrates NAS interaction procedures.

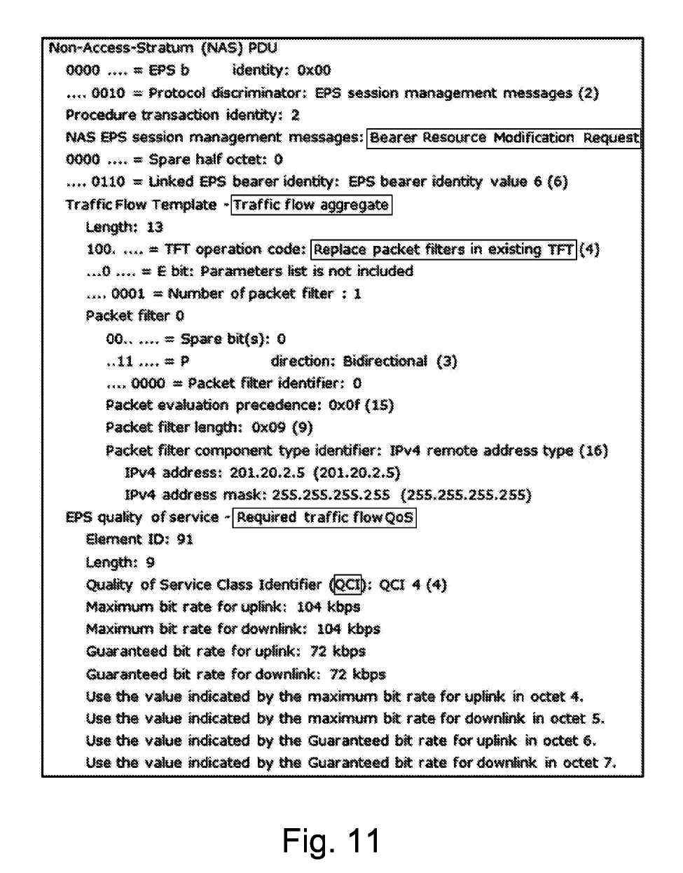

FIG. 11 illustrates an example of a traffic request message given in, for example, the NAS protocol data unit (PDU).

Tables 1 and 2, below, illustrate how Quality-of-Service (QoS) traffic requests can be implemented in a geo-location traffic specification, wherein geo-location traffic data may be classified and prioritised in a first and second time slot, respectively. The tables below represent data for a DAS wherein antenna units are operable on a first network (Wifi) and second network (LTE).

The tables schematically illustrate a potential framework for a geo-location traffic specification according to an embodiment. The table is split into (and thus comprises geo-location traffic specification information for) two networks—Wifi and an LTE cellular network. The table is split into a plurality of areas, areas 1 to 3. Thus traffic requirements are classified by area. Each area is determined by an affiliation with a particular antenna unit (“cell-ID” method).

As well as providing information regarding the network and location of devices represented in the table, an indication of the priority of the device's traffic is also provided. This is represented by a User Priority for devices using Wifi and a QoS Class Identifier (QCI) for devices using the LTE network. All of the above information may be embodied in, and provided by, geo-location traffic data, for example NAS Attach Requests for the LTE network and ADDTS.request/responses for the Wifi network. In the tables below, information for 14 devices is provided. A similar framework may, however, be used as a geo-location traffic specification framework for any number of devices, from a single device to all the devices using the DAS.

The specific protocols for handling such prioritisation are defined in technical standards, (e.g. IEEE Std 802.11-2012 for Wifi) and can be implemented as such in the embodiments described herein.

The tables also illustrate the effect of devices moving around the DAS and changing their traffic requirements. Table 1 shows device traffic specifications during a first time slot. Table 2 shows the device traffic specifications during a second time slot. As is evident, the network, location and the QoS requirements can change over time.

TABLE 1

| | | Area 1 | | |
|---|---|---|---|---|
| | class | (antenna 1) | Area 2 (antenna 2) | Area 3 (antenna 3) |
| Wifi UP | 1 | | | |
| | 2 | Device 1, | | |
| | | Device 3 | | |
| | 0 | | | |
| | 3 | | Device 4 | |
| | 4 | | Device 2, Device 5 | |
| | 5 | | | Device 9 |
| | 6 | | Device 7 | |
| | 7 | | | |
| LTE | 1 | | | |
| QCI | 2 | | | Device 14, |
| | | | | Device 11 |
| | 3 | | Device 6 | |
| | 4 | | Device 8 | |
| | 5 | | | Device 10, |
| | | | | Device 13 |
| | 6 | | | |
| | 7 | | | Device 12 |
| | 8 | | | |
| | 9 | | | |

TABLE 2

| | | Area 1 | | |
|---|---|---|---|---|
| | class | (antenna 1) | Area 2 (antenna 2) | Area 3 (antenna 3) |
| Wifi UP | 1 | | | |
| | 2 | | | |
| | 0 | | | |
| | 3 | | Device 4 | |
| | 4 | | | |
| | 5 | | | |
| | 6 | | | |
| | 7 | Device 1, | | |
| | | Device 3 | | |
| LTE | 1 | | | |
| QCI | 2 | | Device 2, Device 5 | Device 14, |
| | | | | Device 11 |
| | 3 | | Device 6 | |
| | 4 | | Device 8, Device 7 | Device 9 |
| | 5 | | | Device 10, |
| | | | | Device 13 |
| | 6 | | | |
| | 7 | | | Device 12 |
| | 8 | | | |
| | 9 | | | |

While certain embodiments have been described, these embodiments have been presented by way of example only, and are not intended to limit the scope of the inventions. Indeed the novel methods, devices and apparatuses described herein may be embodied in a variety of other forms; furthermore, various omissions, substitutions and changes in the form of methods and apparatuses described herein may be made without departing from the spirit of the inventions. The accompanying claims and their equivalents are intended to cover such forms or modifications as would fall within the scope and spirit of the inventions.

1. A controller for a distributed antenna system, the distributed antenna system comprising a plurality of antenna units, wherein each antenna unit is operable at a first frequency band, defining a first network;
wherein the controller comprises a processor;
the processor being configured to:
receive a geo-location traffic specification;
wherein the geo-location traffic specification comprises an indication of a location of a device using the distributed antenna system and a traffic requirement of the device;
the processor further being configured to:
select an antenna unit or group of antenna units to operate on the first network, based on the received geo-location traffic specification; wherein
the antenna unit or group of antenna units is selected to meet the traffic requirement of the device with respect to the first network, in the location of the device.

2. A controller according to claim 1, wherein an antenna unit is further operable at a second frequency band, defining a second network.

3. A controller according to claim 2, wherein the geo-location traffic specification further comprises an indication of a location of a second device using the distributed antenna system and a traffic requirement of the second device; and
the processor is further configured to select a second antenna unit or second group of antenna units operable on the second network, to operate on the second network, based on the received geo-location traffic specification; wherein
the second antenna unit or second group of antenna units is selected to meet the traffic requirement of the second device with respect to the second network, in the location of the second device.

4. A controller according to claim 2, wherein the first network is a wireless local area network and the second network is a cellular network.

5. A controller according to claim 1, wherein the geo-location traffic specification comprises at least one of a historic geo-location traffic specification and a short-term geo-location traffic specification.

6. A controller according to claim 1, wherein the geo-location traffic specification is derived from Non-access stratum Attach requests of the device using the distributed antenna system.

7. A controller according to claim 1, wherein the geo-location traffic specification is derived from ADDTS.request and/or ADDTS.response data of the device using the distributed antenna system.

8. A controller according to claim 1, wherein the processor is configured to periodically cycle through a time slot, wherein the time slot comprises a first sub-slot in which the processor is configured to receive the geo-location traffic specification and a second sub-slot in which the processor is configured to select the antenna unit or group of antenna units to operate on the first network.

9. A controller according to claim 8, wherein the time slot further comprises a third sub-slot, wherein the processor is configured to permit the device using the distributed antenna system to transmit and/or receive data during the third sub-slot.

10. A controller according to claim 9, wherein the processor is configured to set the length of the third sub-slot dependent on the traffic flow rate of the device using the distributed antenna system.

11. A method for managing a distributed antenna system, the distributed antenna system comprising a plurality of antenna units, wherein each antenna unit is operable at a first frequency band, defining a first network;
the method comprising:
receiving a geo-location traffic specification;
wherein a geo-location traffic specification comprises an indication of a location of a device using the distributed antenna system and a traffic requirement of the device;
the method further comprising:
selecting an antenna unit or group of antenna units to operate on the first network, based on the received geo-location traffic specification; wherein
the antenna unit or group of antenna units is selected to meet the traffic requirement of the device with respect to the first network, in the location of the device.

12. A method according to claim 11, wherein an antenna unit is further operable at a second frequency band, defining a second network.

13. A method according to claim 12, wherein the geo-location traffic specification further comprises an indication of a location of a second device using the distributed antenna system and a traffic requirement of the second device; and the method further comprises:
selecting a second antenna unit or second group of antenna units operable on the second network to operate on the second network, based on the received geo-location traffic specification; wherein the antenna unit or group of antenna units is selected to meet the traffic requirement of the second device using the distributed antenna system with respect to the second network, in the location of the second device.

14. A method according to claim 11, wherein the geo-location traffic specification comprises at least one of a historic geo-location traffic specification and a short-term geo-location traffic specification.

15. A method according to claim 11, wherein the method comprises periodically cycling through a time slot, wherein the time slot comprises a first sub-slot in which the processor is configured to receive the geo-location traffic specification and a second sub-slot in which the processor is configured to select the antenna unit or group of antenna units to operate on the first network.

16. A method according to claim 15, wherein the time slot further comprises a third sub-slot in which the device using the distributed antenna system transmits and/or receives data over the distributed antenna system.

17. A distributed antenna system for providing coverage of a first frequency band, defining a first network; the distributed antenna system comprising:
a plurality of antenna units, each operable on the first network; and
a controller operably connected to the antenna units, the controller comprising a processor;
wherein the processor is configured to:
receive a geo-location traffic specification;
wherein a geo-location traffic specification comprises an indication of a location of a device using the distributed antenna system and a traffic requirement of the device;
the processor further being configured to:
select an antenna unit or group of antenna units to operate on the first network, based on the acquired traffic specification;
wherein the antenna unit or group of antenna units is selected to meet the traffic requirement of the device with respect to the first network, in the location of the device.

18. A distributed antenna system according to claim 17, further comprising:
a hub connecting the controller to at least one of the antenna units.

19. A distributed antenna system according to claim 17, further comprising:
a database operably connected to the controller, the database storing historic geo-location traffic data.

20. A computer readable carrier medium carrying computer executable instructions which, when executed on a processor, cause the processor to carry out a method according to claim 11.
